(19) United States
(12) Patent Application Publication
(10) Pub. No.: US 2014/0372998 A1
(43) Pub. Date: Dec. 18, 2014

(54) APP PACKAGE DEPLOYMENT

(71) Applicant: Microsoft Corporation, Redmond, WA (US)

(72) Inventors: Jason Salameh, Bothell, WA (US); Philip Smith, Renton, WA (US); Andres Carlo Petralli, Seattle, WA (US)

(21) Appl. No.: 13/917,682

(22) Filed: Jun. 14, 2013

(51) Int. Cl. G06F 9/445

(52) U.S. Cl. CPC G06F 8/65
USPC 717/169

(57) ABSTRACT

One or more techniques and/or systems are provided for selectively retrieving a subset of an app package for deployment of an application on a client device. For example, one or more applications may be deployed on the client device. The one or more applications may utilize data object instances stored on the client device (e.g., a UI framework, runtime data, an integrated development environment template, etc.). When deploying a new application on the client device, data objects comprised within an app package for the new application may be evaluated to determine whether corresponding data object instances are already stored on the client device (e.g., a new racing game may utilize the same 3D engine as a skiing game already installed on the client device). Accordingly, merely data objects, not already comprised on the client device, may be retrieved and/or deployed on the client device for deployment of the new application.

### BACKGROUND

Many users utilize applications to perform a variety of activities, such as checking email, playing video games, sharing photos, interacting through social networks, banking, and/or a plethora of other activities. Some applications may be deployed through the use of app packages which may be downloaded from app stores, for example. On occasion different app packages may comprise similar or overlapping data (e.g., integrated development environment (IDE) templates, physics engines, libraries, frameworks, UI controls, game engines, language data, etc.). For example, a game developer may create a driving game app package and a skiing game app package, where both the driving game app package and the skiing game app package may utilize the same UI controls, game engine, physics engine, and/or other data objects.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for selectively providing and/or retrieving a subset of an app package for deployment of an application on a client device are provided herein. For example, an app package may comprise one or more data objects associated with an application (e.g., an executable binary, user interface data, images, audio, language data, 3D game models, etc.). A data object may comprise one or more files or a portion of a file (e.g., a data block, such as a 64 k bit block of data). In an example, the app package and/or other app packages may be exposed through an app store for selective retrieval of one or more data objects by client devices for deployment of applications on such client devices. In particular, a client device may merely retrieve data objects from the app packages that are not already comprised on the client device, thus mitigating unnecessary utilization of upload bandwidth, upload time, download bandwidth, storage space, and/or computing resources during upload (e.g., to the app store), download, deployment, and/or execution of the application on the client device.

In an example, an app package for an application may be indentified (e.g., a skiing game app package may be exposed through an app store). A block map structure for the app package may comprise one or more identifiers (e.g., data object hashes) that uniquely identify data objects comprised within the app package, such as a first identifier for a first data object (e.g., a game engine) and a second identifier for a second data object (e.g., a skiing game music file). The block map structure may be evaluated to determine whether any of the data objects comprised within the app package are already comprised on the client device (e.g., a previously deployed racing game may have stored an instance of the game engine on the client device, where both the skiing game and the racing game utilize the same game engine) or the app store during upload. For example, a determination may be made that a first data object instance of the first data object is comprised on the client device based upon the first identifier corresponding to a first client identifier for the first data object instance (e.g., a data object index comprising client identifiers for data object instances comprised on the client device may be queried utilizing the first identifier to determine that a matching first client identifier is specified within the data object index). A determination may be made that the client device does not comprise the second data object (e.g., a corresponding second data object instance) based upon the second identifier not corresponding to client identifiers for data object instances on the client device. Thus, the client device may already comprise the first data object (e.g., the first data object instance), but may not comprise the second data object (e.g., no corresponding second data object instance). In this way, the second data object, but not the first data object, may be selectively retrieved as a second data object instance for deployment of the application on the client device. In this way, download bandwidth, storage space, and/or computing resources may be efficiently utilized by mitigating download and storage of redundant data objects.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of selectively retrieving a subset of an app package for deployment of an application on a client device.

FIG. 2 is an illustration of an example of a client device comprising one or more deployed applications.

FIG. 3 is an illustration of an example of an app store configured to expose app packages associated with applications available for selective retrieval from the app store.

FIG. 4A is a component block diagram illustrating an exemplary system for determining whether a client device comprises one or more data objects of an app package.

FIG. 4B is a component block diagram illustrating an exemplary system for selectively retrieving a subset of an app package for deployment of an application on a client device.

FIG. 5A is an illustration of an example of selectively updating portions an application on a client device.

FIG. 5B is an illustration of an example of selectively updating portions an application on a client device.

FIG. 6 is an illustration of an exemplary computer readable medium wherein processor-executable instructions configured to embody one or more of the provisions set forth herein may be comprised.

FIG. 7 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide an understanding of the claimed subject matter. It may be evident, however, that the claimed subject matter may be practiced without these specific details. In other instances, structures and devices are illustrated in block diagram form in order to facilitate describing the claimed subject matter.

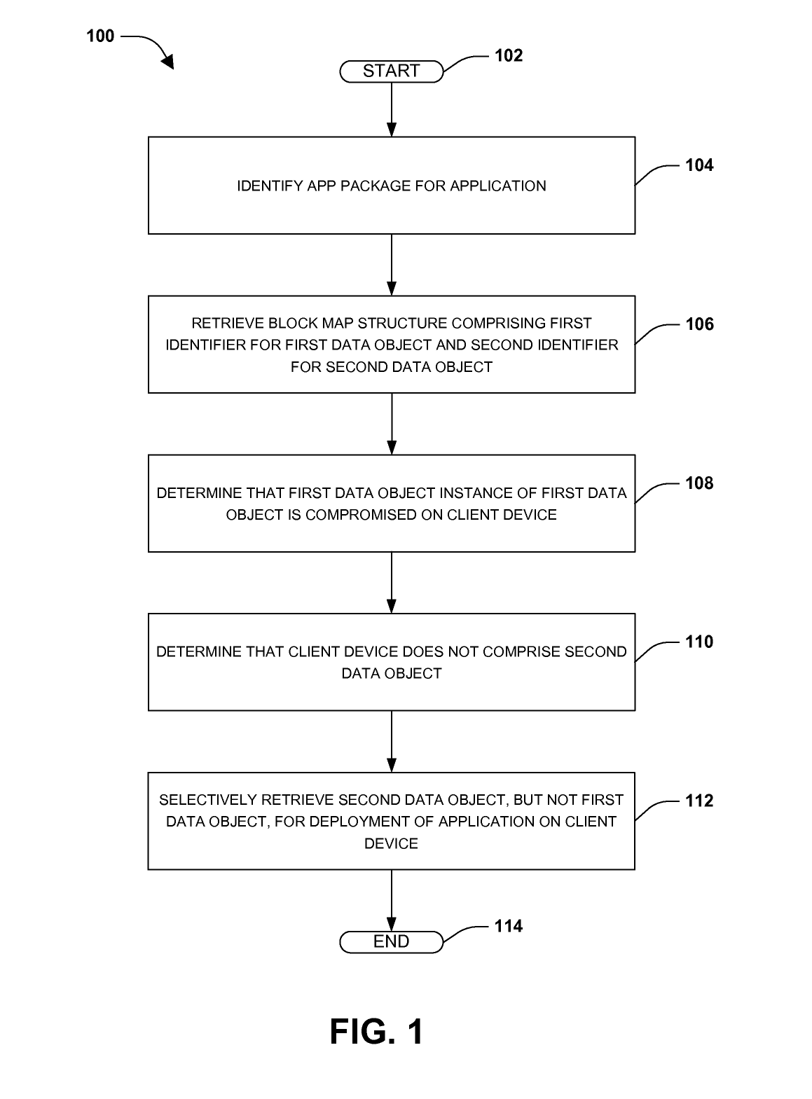

An embodiment of selectively retrieving a subset of an app package for deployment of an application on a client device is illustrated by an exemplary method 100 of FIG. 1. At 102, the method starts. In an example, an app store may expose app packages for applications that may be selectively downloaded and/or deployed on client devices (e.g., a racing game app package, a social network app package, an image sharing app package, etc.). At 104, an app package for an application may be identified (e.g., a role playing game app package for a role playing game may be identified by a client device based upon a user expressing interest in the role playing game). The app package may comprise one or more data objects that may be exposed for selectively download (e.g., the client device may selectively download data objects not already comprised on the client device). A data object may correspond to a file (e.g., a 3D model file) or a data block representing a portion of the file (e.g., a 64k bit chunk of the 3D model file) such that the client device may selectively retrieve portions of the app package at various granularities. For example, the data object may correspond to an integrated development environment template, runtime data, a library, a platform, a game engine, a UI framework, language data, and/or other information used by the application. Because such data objects may be common to multiple applications (e.g., the role playing game and a previously deployed application on the client device may both utilize the 3D model file), it may be advantageous to merely retrieve and/or deploy instances of data objects on the client device in a non-duplicative manner.

At 106, a block map structure comprising identifiers (e.g., hash values uniquely identifying data objects) for the one or more data objects of the app package may be retrieved. For example, the block map structure may comprise a first identifier for a first data object comprised within the app package (e.g., a first hash value of the 3D model file for the role playing game) and a second identifier for a second data object comprised within the app package (e.g., a second hash value of a German translation file for the role playing game). The block map structure may be evaluated (e.g., against a data object index maintained by the client device) to determine whether any of the data objects of the app package are already comprised as data object instances on the client device, such that the client device does not retrieve and/or deploy duplicate data objects on the client device so that unnecessary utilization of download bandwidth, storage space, and/or computing resources may be mitigated. In an example, the data object index comprises a set of client identifiers for data object instances comprised on the client device. A client identifier may comprise a hash of a data object instance on the client device that distinctly identifies the data object instance.

At 108, a determination may be made that a first data object instance of the first data object is comprised on the client device based upon the first identifier corresponding to a first client identifier for the first data object instance (e.g., the client device may already comprise a 3D model file instance based upon a previous deployment of a strategy game that utilizes the same 3D models). For example, the first identifier (e.g., the first hash value) may be used to query the data object index to determine that the first client identifier (e.g., the first hash value) matches the first identifier. Thus, the first data object may not be retrieved from the app store because the first data object instance is already stored on the client device.

At 110, a determination may be made that the client device does not comprise the second data object (e.g., a corresponding second data object instance) based upon the second identifier not corresponding to client identifiers for data object instances on the client device (e.g., the client device may not comprise a German translation file instance). For example, the second identifier (e.g., the second hash value) may be used to query the data object index to determine that no client identifiers within the data object index match the second hash value. At 112, the second data object, but not the first data object, may be selectively retrieved as a second data object instance for deployment of the application on the client device. A reference (e.g., a hard link, a pointer, etc.) may be specified between the application and the first data object instance. Thus, the application may utilize the reference to access the first data object instance during execution even though the first data object instance may be associated with a different application deployed on the client device (e.g., the role playing game may utilize the reference to access the 3D model file associated with the strategy game). In this way, responsive to receiving execution input associated with the application, the application may be executed using the first data object instance.

The data object index may be maintained where client identifiers may be added, modified, and/or removed from the data object index. In an example, a second client identifier for the second data object instance may be specified within the data object index based upon retrieval of the second data object and/or the deployment of the application. In another example, client identifiers, associated with one or more data object instances of a deployed app package, may be removed from the data object index based upon removal of a deployed application associated with the deployed app package.

In an example, the application, deployed on the client device, may be updated (e.g., a version 1 of the role playing game may be updated to a version 2 of the role playing game) in a manner where merely new data objects and/or modified data objects, but not duplicate data objects, may be selectively retrieved for update. For example, an update for the application may be identified (e.g., the app store may post a notification of an available update for the role playing game). The update may specify an updated application version of the application (e.g., version 2 of the role playing game). An updated block map structure for the updated application version may be retrieved. For example, the updated block map structure may comprise the second identifier for the second data object (e.g., the German translation file may remain unchanged from version 1 to version 2) and a third identifier for a third data object (e.g., an audio file comprising new music for the version 2 of the role playing game).

A determination may be made that the second data object instance of the second data object is comprised on the client device based upon the second identifier corresponding to the second client identifier for the second data object instance, and thus the second data object may not be retrieved for updating the application because the client device already comprises the second data object. A determination may be made that the client device does not comprise the third data object based upon the third identifier not corresponding to client identifiers for data object instances on the client device. In this way, the third data object, but not the second data object, may be selectively retrieved as a third data object instance for deployment (e.g., updating) of the updated application version of the application (e.g., version 2 of the role playing game). In an example where the second data object corresponds to a different application deployed on the client device, the second data object instance may be copied to create a copied second data object instance for deployment of the updated application version of the application (e.g., version 2 of the role playing game may utilize the copied second data object instance). It may be appreciated that in an example where data objects correspond to data blocks representing portions of a file, a portion of a file may be selectively updated by retrieving portions of the file not already comprised on the client device (e.g., a 3D model file may be updated with merely a new character model not already comprised within the 3D model file, and thus merely the new character model may be retrieved whereas unchanged portions of the 3D model file may not be retrieved). At 114, the method ends.

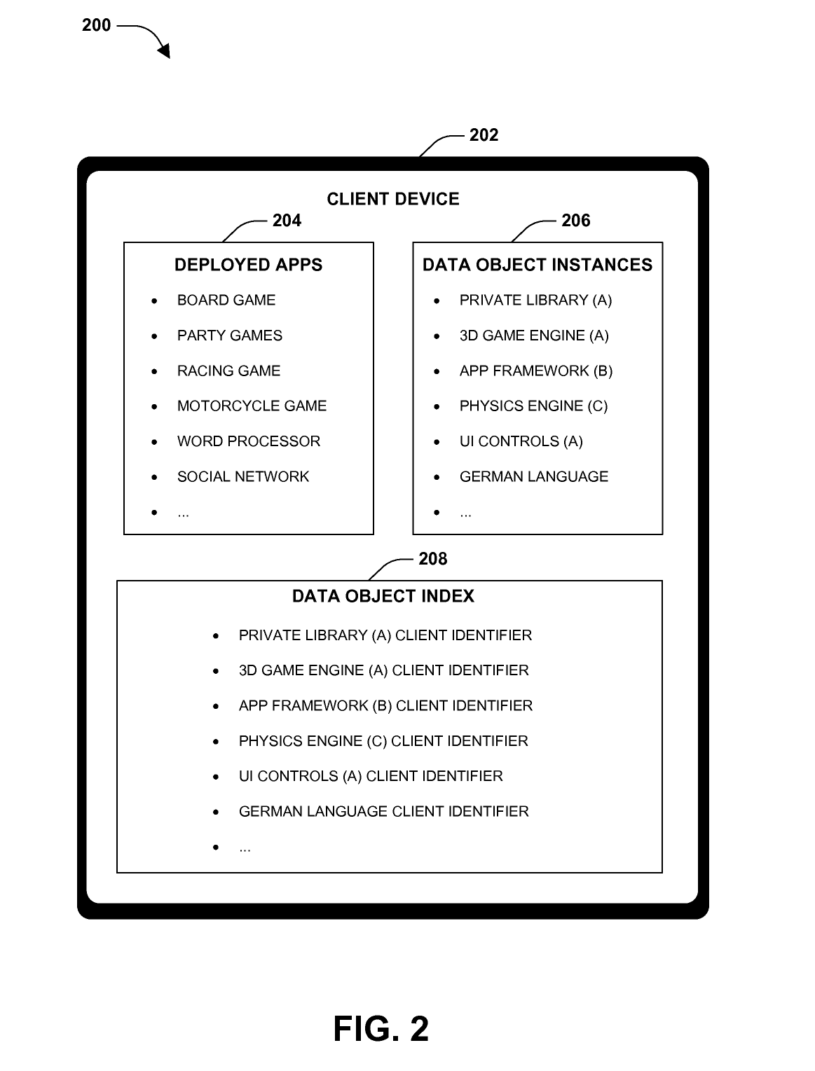

FIG. 2 illustrates an example 200 of a client device 202 comprising one or more deployed applications 204. The client device 202 may comprise a tablet device, a mobile device, a desktop device, or any other computing device. In an example, a user may have deployed (e.g., installed from an app store, deployed through an enterprise install, locally installed by the user, etc.) a board game application, a party games application, a racing game application, a motorcycle game application, a word processor application, a social network application, and/or a variety of other applications. The deployed applications 204 may be associated with data object instances 206 (e.g., files, data blocks representing portions of files, etc.) that may comprise data used by the deployed applications 204. For example, the data object instances 206 may comprise a private library (A) data object instance (e.g., one or more functions utilized by the board game application and the party games application), a 3D game engine (A) data object instance (e.g., utilized by the racing game application and the motorcycle game application), an app framework (B) data object instance (e.g., utilized by the social network application), a physics engine (C) data object instance (e.g., utilized by the racing game application app), a UI controls (A) data object instance (e.g., one or more user interface controls utilized by the word processor application and the social network application), and/or other data object instances utilized by applications deployed on the client device 202.

A data object index 208 may be maintained for the client device 202. The data object index 208 may comprise a set of client identifier for the data object instances 206 comprised on the client device 202. For example, the data object index 208 may comprise a private library (A) client identifier (e.g., a hash of the private library (A) data object instance), 3D game engine (A) client identifier (e.g., a hash of the 3D game engine (A) data object instance), and/or other client identifiers for data object instances comprised on the client device 202. In this way, the data object index 208 may be efficiently queried to determine what data object instances are comprised on the client device 202. For example, the data object index 208 may be queried to determine whether a data object is to be retrieved (e.g., based upon the client device 202 not comprising a corresponding data object instance) or not (e.g., based upon the client device 202 already comprising a corresponding data object instance) for deployment of an application associated with an app package comprising the data object.

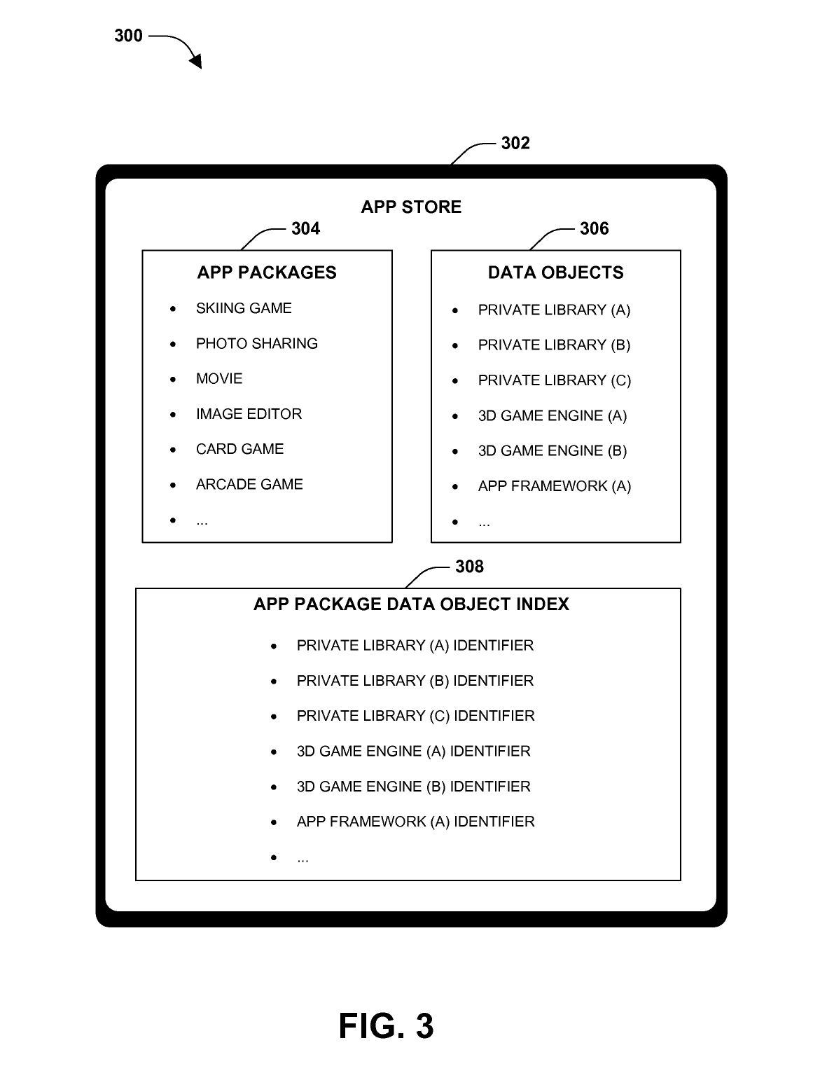

FIG. 3 illustrates an example 300 of an app store 302 configured to expose app packages 304 associated with applications available for selective retrieval from the app store 302. In an example, the app store 302 may expose a skiing game app package, a photo sharing app package, a movie app app package, an image editor app package, a card game app package, an arcade game app package, and/or a variety of other app packages for applications that may be retrieved by client devices for deployment (e.g., installation) on such client devices. The app packages 304 may be associated with one or more data objects 306 (e.g., files, data blocks representing portions of files, etc.) that may comprise data used by client devices to execute applications associated with the app packages 304. For example, the data objects 306 may comprise a private library (A) data object (e.g., one or more functions utilized by a card game application), a private library (B) data object (e.g., one or more functions utilized by a movie app application and an image editor application), a private library (C) data object (e.g., one or more functions utilized by an arcade game application), a 3D game engine (A) data object (e.g., utilized by a skiing game application), a 3D game engine (B) data object (e.g., utilized by an arcade game application), an app framework (A) data object (e.g., utilized by a movie app application and an image editor application), and/or other data objects utilized by applications associated with the app packages 304.

An app package data object index 308 may be maintained by the app store 302. The app package data object index 308 may comprise a set of identifiers for the data objects 306 available for selective retrieval from the app store 302. For example, the app package data object index 308 may comprise a private library (A) identifier (e.g., a hash of the private library (A) data object), a private library (B) identifier (e.g., a hash of the private library (B) data object), a private library (C) identifier (e.g., a hash of the private library (C) data object), a 3D game engine (A) identifier (e.g., a hash of the 3D game engine (A) data object), and/or other identifiers for data objects 306 associated with the app packages 304. In an example, the app package data object index 308 may be used to perform deduplication upon data objects 306 maintained by the app store 302 to mitigate redundant storage of data objects by the app store 302. In another example, the app package data object index 308 may be used to determine whether a client device already comprises a data object (e.g., a data object instance) within the data objects 306, such that the data object is not redundantly provided to the client device for deployment of an application.

In an example, new app packages may be created and/or uploaded to the app store 302. For example, a package management component, associated with the app store 302, may be configured to receive a new app package creation request. The new app package creation request may specify that a new app package is to be associated with a first data object (e.g., not already stored within the app store 302) and a second data object (e.g., already stored within the app store 302). The new app package comprising the first data object and a new reference (e.g., a hard link) to the second data object may be created based upon the first data object not already being stored within the app store 302 and based upon the second data object already being stored within the app store 302. A new block map structure may be generated for the new app package. The new block map structure may comprise a first identifier for the first data object and a second identifier for the second data object. The new app package may be exposed for selective retrieval of one or more data objects associated with the new app package. For example, responsive to receiving a block map request for the new block map structure from a client device, the new block map structure may be provided to the client device. If the first data object and the second data object are not already stored on the client device, then the first data object and the second data object may be provided to the client device for deployment of a new application associated with the new app package.

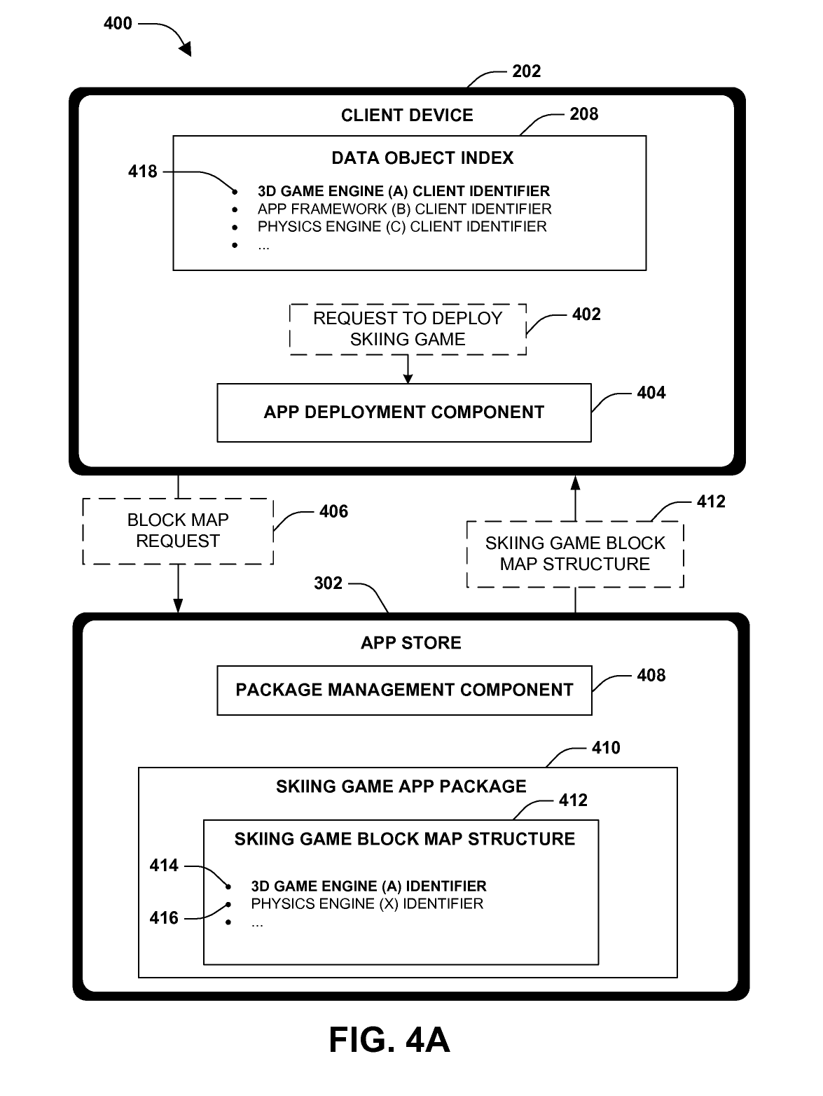

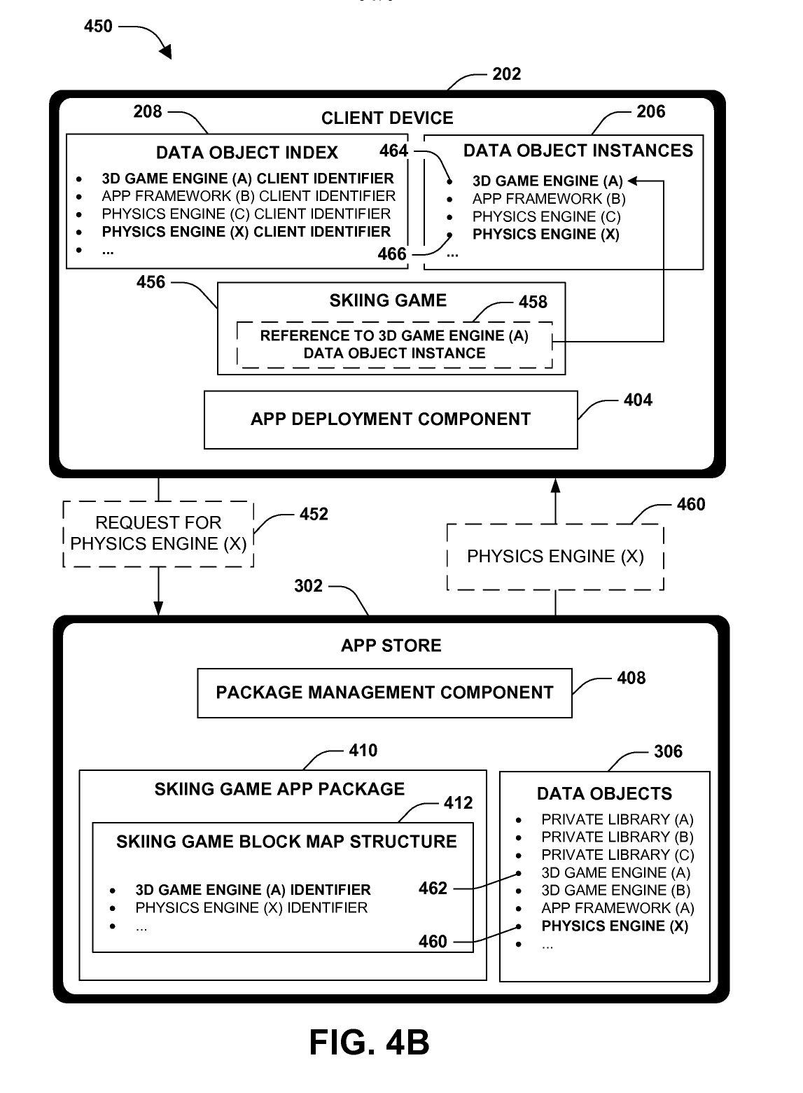

FIG. 4A illustrates an example of a system 400 for determining whether a client device 202 comprises one or more data objects of an app package. In an example, the system 400 may comprise an app deployment component 404 (e.g., an implementation of the system 400 on the client device 202). In another example, the system 400 may comprise a package management component 408 (e.g., an implementation of the system 400 at an app store 302, such as app store 302 of FIG. 3). The client device 202 may comprise one or more applications that were deployed on the client device 202 (e.g., FIG. 2). For example, a racing game application may have been deployed on the client device 202. The racing game application may be associated with a 3D game engine (A) data object instance and/or other data object instances comprised on the client device 202. The client device 202 may comprise a data object index 208 comprising a set of client identifiers for data object instances comprised on the client device (e.g., a 3D game engine (A) client identifier 418 for the 3D game engine (A) data object instance associated with the racing game). The app deployment component 404 may be configured to query the data object index 208 to determine whether a data object instance, corresponding to a data object of an application that is to be retrieved and/or deployed on the client device 202, is already comprised on the client device 202.

In an example, the app deployment component 404 may receive a request 402 to retrieve and deploy a skiing game application on the client device 202. The app deployment component 404 may identify a skiing game app package 410 exposed through the app store 302 (e.g., exposed by the package management component 408). The skiing game app package 410 may be associated with a skiing game block map structure 412 that may comprise one or more identifiers for data objects comprised within the skiing game app package 410. For example, the skiing game block map structure 412 may comprise a 3D game engine (A) identifier for a 3D game engine (A) data object, a physics engine (X) identifier 416 for a physics engine (X) data object, and/or other identifiers for data objects comprised within the skiing game app package 410 (e.g., identifiers such as hash values uniquely identifying data objects). The app deployment component 404 may be configured to retrieve the skiing game block map structure 412 (e.g., the package management component 408 may be configured to receive a block map request 406 from the client device 202, and provide the skiing game block map structure 412 to the client device 202).

The app deployment component 404 may query the data object index 208 utilizing the 3D game engine (A) identifier 414 to determine that the 3D game engine data object instance, corresponding to the 3D game engine data object within the skiing game app package 410, is comprised on the client device 202 based upon the 3D game engine (A) identifier 414 matching the 3D game engine (A) client identifier 418. The app deployment component 404 may query the data object index 208 utilizing the physics engine (X) identifier to determine that the client device 202 does not comprise a physics engine (X) data object instance, corresponding to the physics engine (X) data object within the skiing game app package 410, based upon the physics engine (X) identifier 416 not matching a client identifier within the data object index 208. In this way, the app deployment component 404 may selectively retrieve the physics engine (X) data object, but not the 3D game engine (A) data object, based upon the client device 202 already comprising the 3D game engine (A) data object instance and not comprising a physics engine (X) data object instance (e.g., FIG. 4B).

FIG. 4B illustrates an example of a system 450 for selectively retrieving a subset of an app package for deployment of an application on a client device. It may be appreciated that in one example, system 450 may correspond to system 400 of FIG. 4A. That is, system 450 may comprise an app deployment component 404 (e.g., an implementation of the system 400 and/or the system 450 on the client device 202). In another example, the system 400 may comprise a package management component 408 (e.g., an implementation of the system 400 and/or the system 450 at an app store 302). The app deployment component 404 may have retrieved and evaluated a skiing game block map structure 412 for a skiing game app package 410 to determine that a physics engine (X) data object 460, but not a 3D game engine (A) data object 462, is to be selectively retrieved for deployment of a skiing game application 456 on the client device 202 (e.g., because the client device 202 does not comprise a data object instance corresponding to the physics engine (X) data object 460, and because the client device 202 already comprises a 3D game engine (A) data object instance 464).

In an example, the app deployment component 404 may selectively retrieve the physic engine (X) data object 460, but not the 3D game engine (A) data object 462 (e.g., the package management component 408 may be configured to receive a request 452 for the physics engine (X) data object 460, and provide the physics engine (X) data object 460 to the client device 202). The app deployment component 404 may store the physics engine (X) data object 460 as a physics engine (X) data object instance 466 on the client device 202 for utilization by the skiing game application 456. The app deployment component 404 may create a reference 458 (e.g., hard link, etc.) between the skiing game application 456 and the game engine (A) data object instance 464. The skiing game application 456 may utilize the reference 458 to access the 3D game engine (A) data object instance 464 during execution of the skiing game application 456. In this way, the skiing game application 456 may be deployed on the client device 202 without using unnecessary bandwidth, storage space, and/or computing resources that would otherwise be used to retrieve and deploy a duplicate copy of the 3D game engine (A) data object 462.

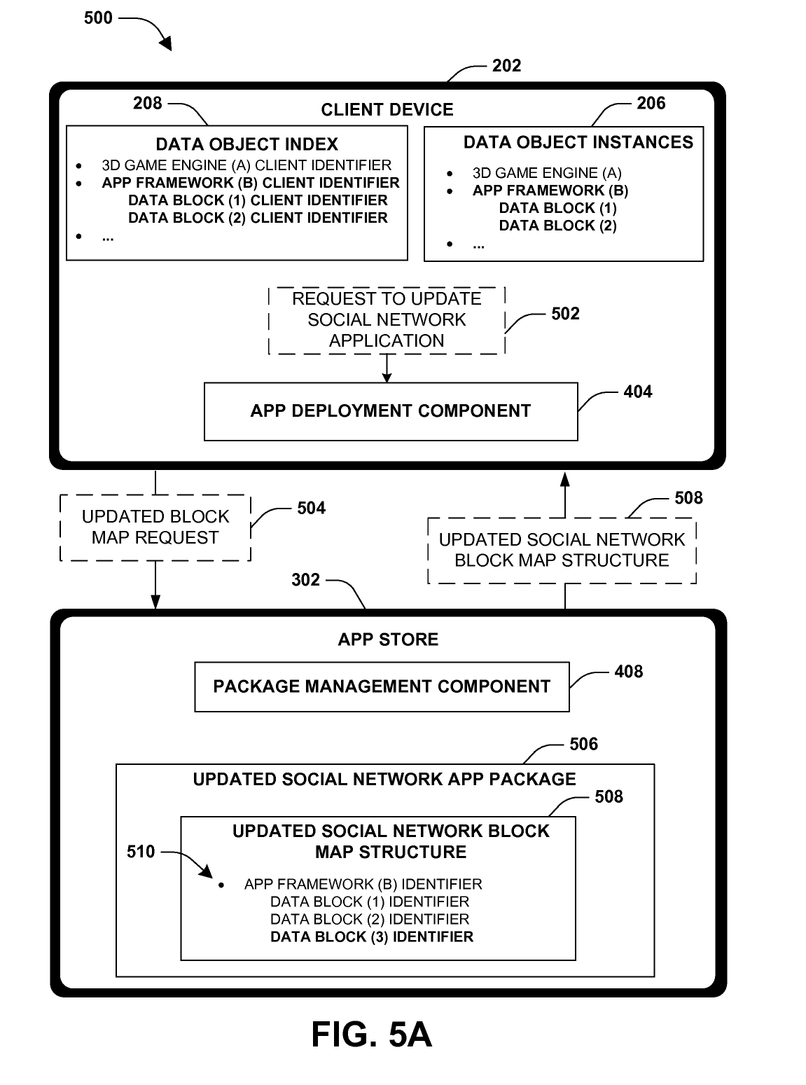

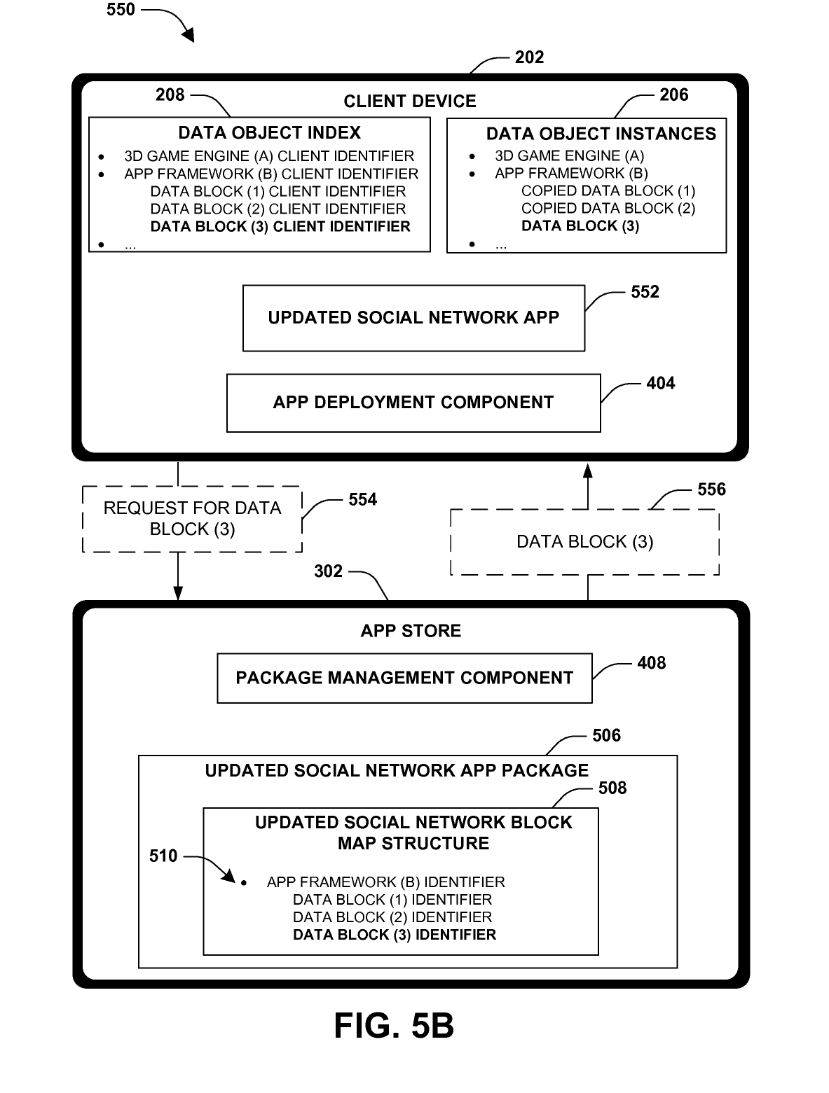

FIG. 5A illustrates an example 500 of selectively updating portions an application on a client device 202. In an example, a client device 202 may have one or more applications deployed on the client device 202. Such applications may utilize data object instances 206 for execution (e.g., a racing game application may utilize a 3D game engine (A) data object instance; a social network application may utilize an app framework (B) data object instance; etc.). In an example, a data object instance may be defined at various granularities, such as the app framework (B) data object instance or a portion thereof (e.g., a data block (1) of the app framework (B) data object instance, a data block (2) of the app framework (B) data object instance, and/or other data blocks comprising data of the app framework (B) data object instance). The client device 202 may comprise a data object index 208 comprising a set of client identifiers for data object instances 206 comprised on the client device 202. For example, an app framework (B) client identifier may uniquely identify the app framework (B) data object instance, a data block (1) client identifier may uniquely identify the data block (1) data object instance, a data block (2) client identifier may uniquely identify the data block (2) data object instance, etc. In this way, an app deployment component 404 may query the data object index 208 to determine what data object instances are comprised on the client device 202.

In an example, the app deployment component 404 may identify an update for a social network application deployed on the client device (e.g., request 502). The app deployment component 404 may retrieve an updated social network block map structure 508 comprising one or more identifiers 510 for data objects associated with an updated social network app package 506 (e.g., a package management component 408 associated with an app store 302, exposing the updated social network app package 506 for selective retrieval, may receive an updated block map request 504, and may provide the updated social network block map structure 508 to the client device 202). The app deployment component 404 may query the data object index 208 using the one or more identifiers 510 in order to identify which data objects are already stored on the client device 202 as data object instances 206 (e.g., based upon identifiers within the updated social network block map structure 508 matching client identifiers within the data object index 208). For example, the app deployment component 404 may determine that a data block (1) identifier matches the data block (1) client identifier within the data object index 208, and that a data block (2) identifier matches the data block (2) client identifier within the data object index 208. In this way, the app deployment component 404 may determine that the data block (1) data object and the data block (2) data object associated with the updated social network app package 506 are not to be retrieved for updating the social network application because the client device 202 already comprises the data block (1) data object instance and the data block (2) object instance. The app deployment component 404 may determine that the client device 202 does not comprise a data object instance corresponding to a data block (3) data object based upon a data block (3) identifier not matching a client identifier within the data object index 208. In this way, the app deployment component 404 may selectively retrieve the data block (3) data object, but not the data block (1) data object or the data block (2) data object, based upon the client device 202 already comprising the data block (1) data object instance and the data block (2) data object instance, but not comprising a data block (3) data object instance (e.g., FIG. 5B).

FIG. 5B illustrates an example 550 of selectively updating portions an application on a client device 202. It may be appreciated that in one example, the client device 202 may correspond to client device 202 of FIG. 5A. That is, the client device 202 may comprise an app deployment component 404 that may have identified an update to a social network application deployed on the client device 202. The app deployment component 404 may have determined that a data block (3) data object, but not a data block (1) data object or a data block (2) data object, is to be selectively retrieved for updating the social network application because the client device 202 already comprises a data block (1) data object instance and a data block (2) data object instance, but does not comprise a data block (3) data object instance. Accordingly, the app deployment component 404 may retrieve the data block (3) data object 556 for updating the social network app as an updated social network app 552 on the client device 202 (e.g., a package management component 408, associated with an app store 302 exposing an updated social network app package 506 for selectively download, may receive a request 554 for the data block (3) data object, and may provide the data block (3) data object 556, associated with the updated social network app package 506, to the client device 202).

The app deployment component 404 may store the data block (3) data object as a data block (3) data object instance for utilization by the updated social network app 552. In an example, the app deployment component 404 may copy the data block (1) data object instance and the data block (2) data object instance as a copied data block (1) data object instance and a copied data block (2) data object instance for utilization by the updated social network app 552. In this way, the social network app may be selectively updated (e.g., at a data block granularity) such that redundant data blocks, already stored on the client device 202, are not retrieved for utilization by the updated social network app 552 (e.g., from the app store 302), thus mitigating unnecessary bandwidth utilization.

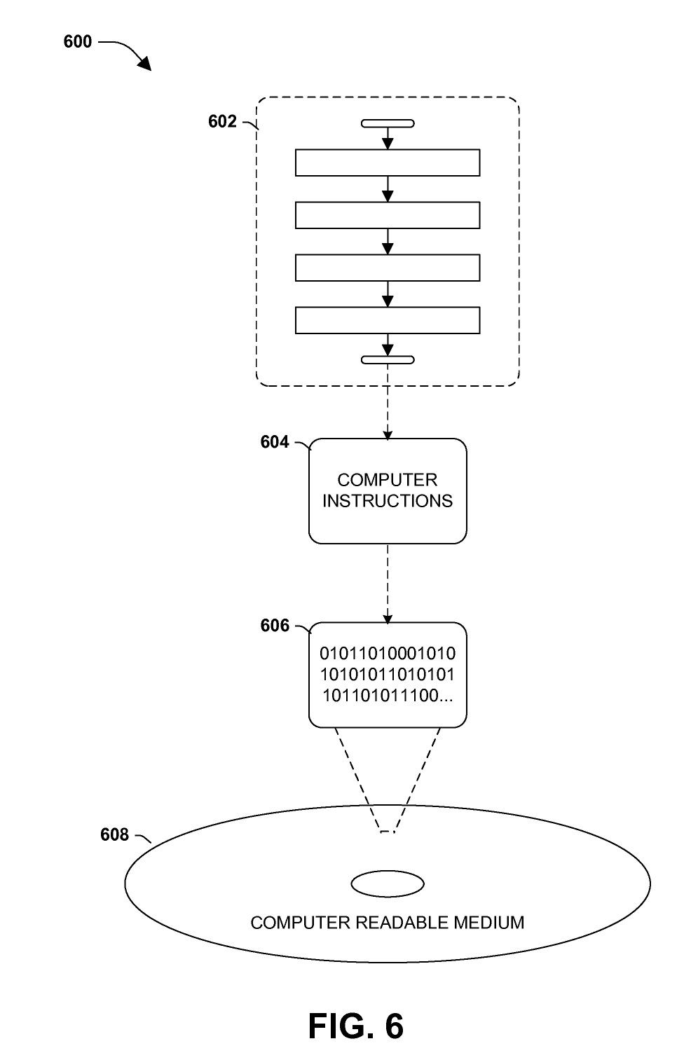

Still another embodiment involves a computer-readable medium comprising processor-executable instructions configured to implement one or more of the techniques presented herein. An example embodiment of a computer-readable medium or a computer-readable device that is devised in these ways is illustrated in FIG. 6, wherein the implementation 600 comprises a computer-readable medium 608, such as a CD-R, DVD-R, flash drive, a platter of a hard disk drive, etc., on which is encoded computer-readable data 606. This computer-readable data 606, such as binary data comprising at least one of a zero or a one, in turn comprises a set of computer instructions 604 configured to operate according to one or more of the principles set forth herein. In some embodiments, the processor-executable computer instructions 604 are configured to perform a method 602, such as at least some of the exemplary method 100 of FIG. 1, for example. In some embodiments, the processor-executable instructions 604 are configured to implement a system, such as at least some of the exemplary system 400 of FIG. 4A and/or at least some of the exemplary system 450 of FIG. 4B, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

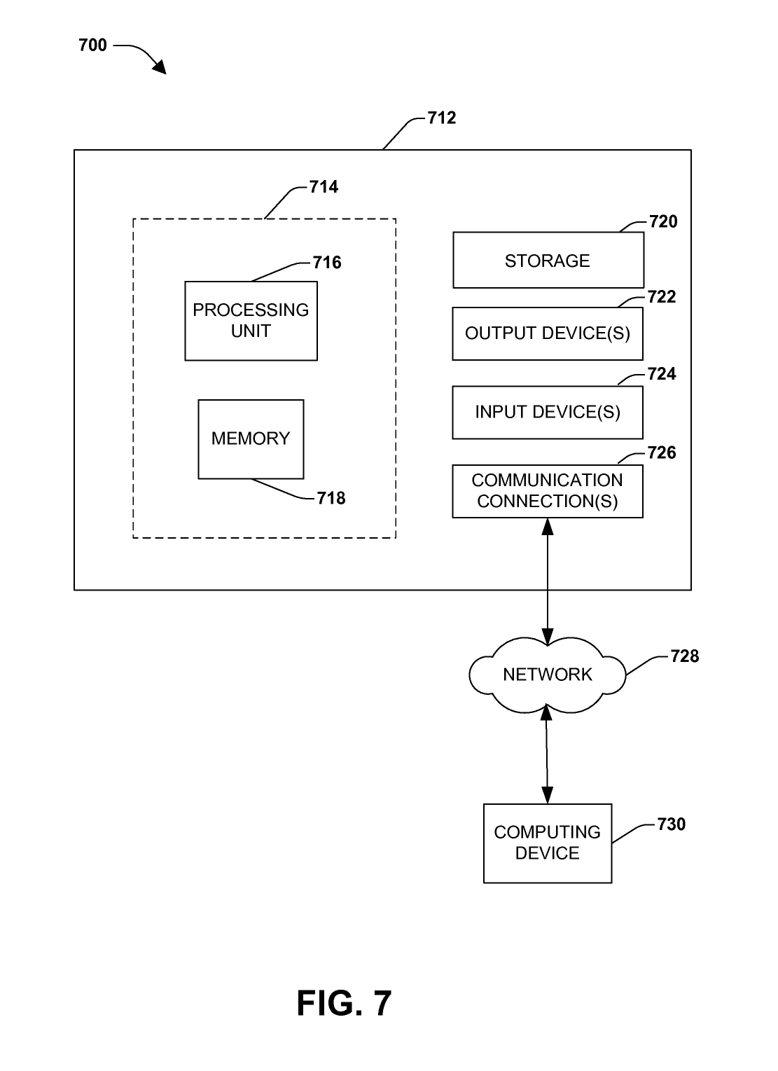

FIG. 7 and the following discussion provide a brief, general description of a suitable computing environment to implement embodiments of one or more of the provisions set forth herein. The operating environment of FIG. 7 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 7 illustrates an example of a system 700 comprising a computing device 712 configured to implement one or more embodiments provided herein. In one configuration, computing device 712 includes at least one processing unit 716 and memory 718. Depending on the exact configuration and type of computing device, memory 718 may be volatile (such as RAM, for example), non-volatile (such as ROM, flash memory, etc., for example) or some combination of the two. This configuration is illustrated in FIG. 7 by dashed line 714.

In other embodiments, device 712 may include additional features and/or functionality. For example, device 712 may also include additional storage (e.g., removable and/or non-removable) including, but not limited to, magnetic storage, optical storage, and the like. Such additional storage is illustrated in FIG. 7 by storage 720. In one embodiment, computer readable instructions to implement one or more embodiments provided herein may be in storage 720. Storage 720 may also store other computer readable instructions to implement an operating system, an application program, and the like. Computer readable instructions may be loaded in memory 718 for execution by processing unit 716, for example.

The term “computer readable media” as used herein includes computer storage media. Computer storage media includes volatile and nonvolatile, removable and non-removable media implemented in any method or technology for storage of information such as computer readable instructions or other data. Memory 718 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 712. Any such computer storage media may be part of device 712.

Device 712 may also include communication connection(s) 726 that allows device 712 to communicate with other devices. Communication connection(s) 726 may include, but is not limited to, a modem, a Network Interface Card (NIC), an integrated network interface, a radio frequency transmitter/receiver, an infrared port, a USB connection, or other interfaces for connecting computing device 712 to other computing devices. Communication connection(s) 726 may include a wired connection or a wireless connection. Communication connection(s) 726 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 712 may include input device(s) 724 such as keyboard, mouse, pen, voice input device, touch input device, infrared cameras, video input devices, and/or any other input device. Output device(s) 722 such as one or more displays, speakers, printers, and/or any other output device may also be included in device 712. Input device(s) 724 and output device(s) 722 may be connected to device 712 via a wired connection, wireless connection, or any combination thereof. In one embodiment, an input device or an output device from another computing device may be used as input device(s) 724 or output device(s) 722 for computing device 712.

Components of computing device 712 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 712 may be interconnected by a network. For example, memory 718 may be comprised of multiple physical memory units located in different physical locations interconnected by a network.

Those skilled in the art will realize that storage devices utilized to store computer readable instructions may be distributed across a network. For example, a computing device 730 accessible via a network 728 may store computer readable instructions to implement one or more embodiments provided herein. Computing device 712 may access computing device 730 and download a part or all of the computer readable instructions for execution. Alternatively, computing device 712 may download pieces of the computer readable instructions, as needed, or some instructions may be executed at computing device 712 and some at computing device 730.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application.

What is claimed is:

1. A method for selectively retrieving a subset of an app package for deployment of an application on a client device, comprising:
identifying an app package for an application, the app package comprising one or more data objects;
retrieving a block map structure comprising a first identifier for a first data object comprised within the app package and a second identifier for a second data object comprised within the app package;
determining that a first data object instance of the first data object is comprised on a client device based upon the first identifier corresponding to a first client identifier for the first data object instance;
determining that the client device does not comprise the second data object based upon the second identifier not corresponding to client identifiers for data object instances on the client device; and
selectively retrieving the second data object, but not the first data object, as a second data object instance for deployment of the application on the client device.

2. The method of claim 1, the first data object corresponding to at least one of a file or a data block representing a portion of the file.

3. The method of claim 1, comprising:
specifying a reference between the application and the first data object instance, the reference used by the application to access the first data object instance during execution.

4. The method of claim 1, comprising:
responsive to receiving execution input associated with the application, executing the application using the first data object instance.

5. The method of claim 1, the first data object instance associated with a second application deployed on the client device.

6. The method of claim 1, the identifying comprising identifying the app package, exposed through an app store, for selective retrieval of the one or more data objects.

7. The method of claim 1, the first data object instance corresponding to at least one of an integrated development environment template, runtime data, a library, a platform, a game engine, or a UI framework common to both the application and a second application deployed on the client device.

8. The method of claim 1, comprising:
maintaining a data object index comprising a set of client identifiers for data object instances comprised on the client device, a client identifier comprising a hash of a data object instance that distinctly identifies the data object instance.

9. The method of claim 8, the first identifier comprising a first hash for the first data object, and the determining that a first data object instance of the first data object is comprised on a client device comprising:
querying the data object index utilizing the first hash to identify the first client identifier, within the data object index, as comprising the first hash.

10. The method of claim 8, the second identifier comprising a second hash for the second data object, and the determining that the client device does not comprise the second data object comprising:
querying the data object index utilizing the second hash to determine that no client identifiers, within the data object index, correspond to the second hash.

11. The method of claim 1, comprising:
identifying an update for the application deployed on the client device, the update specifying an updated application version of the application;
retrieving an updated block map structure comprising the second identifier for the second data object and a third identifier for a third data object;
determining that the second data object instance of the second data object is comprised on the client device based upon the second identifier corresponding to a second client identifier for the second data object instance;
determining that the client device does not comprise the third data object based upon the third identifier not corresponding to client identifiers for data object instances on the client device; and
selectively retrieving the third data object, but not the second data object, as a third data object instance for deployment of the updated application version of the application.

12. The method of claim 11, comprising:
copying the second data object instance to create a copied second data object instance for deployment of the updated application version of the application.

13. The method of claim 8, the maintaining a data object index comprising:
responsive to removal of a deployed app package, removing client identifiers corresponding to one or more data object instances of the deployed app package.

14. A system for selectively providing a subset of an app package for deployment of an application on a client device, comprising:
a package management component configured to:
receive a block map request from a client device, the block map request corresponding to an app package exposed for selective retrieval of one or more data objects comprised within the app package;
provide a block map structure for the app package to the client device, the block map structure comprising a first identifier for a first data object comprised within the app package and a second identifier for a second data object comprised within the app package;
receive a request for the second data object, but not the first data object, based upon a first data object instance of the first data object being comprised on the client device and the second data object not being comprised on the client device; and
provide the second data object, but not the first data object, to the client device for deployment of the application on the client device.

15. The system of claim 14, the package management component associated with an app store configured to expose app packages, and the package management component configured to:
maintaining an app package data object index comprising a set of identifiers for data objects stored within the app store.

16. The system of claim 14, the package management component configured to:
receive a new app package creation request, the new app package creation request comprising a third data object and a fourth data object;
create a new app package comprising the third data object and a new reference to the fourth data object based upon the third data object not being stored within the app store and based upon the fourth data object being stored within the app store;
generating a new block map structure comprising a third identifier for the third data object and a fourth identifier for the fourth data object; and
exposing the new app package for selective retrieval of one or more data objects comprised within the new app package.

17. The system of claim 16, the package management component configured to:
receive a second block map request from a second client device, the second block map request corresponding to the new app package;
provide the new block map structure for the new app package to the client device;
receive a request for the third data object and the fourth data object; and
provide the third data object and the fourth data object to the second client device.

18. A system for selectively retrieving a subset of an app package for deployment of an application on a client device, comprising:
an app deployment component configured to:
identify an app package for an application, the app package comprising one or more data objects;
retrieve a block map structure comprising a first identifier for a first data object comprised within the app package and a second identifier for a second data object comprised within the app package;
determine that a first data object instance of the first data object is comprised on a client device based upon the first identifier corresponding to a first client identifier for the first data object instance;
determine that the client device does not comprise the second data object based upon the second identifier not corresponding to client identifiers for data object instances on the client device; and
selectively retrieve the second data object, but not the first data object, as a second data object instance for deployment of the application on the client device.

19. The system of claim 18, the app deployment component configured to:
specify a reference between the application and the first data object instance, the reference used by the application to access the first data object instance during execution.

20. The system of claim 18, comprising:
an update component configured to:
identify an update for the application deployed on the client device, the update specifying an updated application version of the application;
retrieve an updated block map structure comprising the second identifier for the second data object and a third identifier for a third data object;
determine that the second data object instance of the second data object is comprised on the client device based upon the second identifier corresponding to a second client identifier for the second data object instance;
determine that the client device does not comprise the third data object based upon the third identifier not corresponding to client identifiers for data object stances on the client device; and
selectively retrieve the third data object, but not the second data object, as a third data object instance for deployment of the updated application version of the application.
